(19) United States
(12) Patent Application Publication
(10) Pub. No.: US 2021/0297321 A1
(43) Pub. Date: Sep. 23, 2021

(54) SPARSE LINK-STATE FLOODING

(71) Applicant: NOKIA SOLUTIONS AND NETWORKS OY, Espoo (FI)

(72) Inventors: Gunter Van de Velde, Lint (BE); Henk Smit, Berg en Dal (NL)

(21) Appl. No.: 17/342,628

(22) Filed: Jun. 9, 2021

Related U.S. Application Data
(63) Continuation of application No. 16/128,755, filed on Sep. 12, 2018.

(51) Int. Cl. H04L 12/24; H04L 12/721

(52) U.S. Cl. CPC H04L 41/12; H04L 45/32

(57) ABSTRACT

Various example embodiments for supporting link-state flooding for routing protocols may be configured to support sparse link-state flooding for routing protocols. Various example embodiments for supporting sparse link-state flooding for routing protocols may be configured to support sparse link-state flooding for routing protocols by supporting distributed establishment of a sparse link-state flooding topology. Various example embodiments for supporting link-state flooding for routing protocols may be configured to support sparse link-state flooding for routing protocols based on processes for enabling routers to identify and clamp onto a sparse link-state flooding topology. Various example embodiments for supporting link-state flooding for routing protocols may be configured to support sparse link-state flooding for routing protocols based on use of an anchor node for a sparse link-state flooding topology and based on processes for enabling routers to identify and clamp onto a sparse link-state flooding topology based on identification of paths to the anchor node for the sparse link-state flooding topology.

### CROSS-REFERENCE TO RELATED APPLICATIONS

This application is a continuation of U.S. patent application Ser. No. 16/128,755, filed on Sep. 12, 2018, entitled “SPARSE LINK-STATE FLOODING,” which application is hereby incorporated herein by reference in its entirety.

### TECHNICAL FIELD

Various example embodiments relate generally to communication networks and, more particularly but not exclusively, link-state flooding for routing protocols in communication networks.

### BACKGROUND

Communication networks support communication of data via communication paths which may be controlled based on various routing protocols.

### SUMMARY

In at least some example embodiments, an apparatus includes at least one processor and at least one memory including computer program code, wherein the at least one memory and the computer program code are configured to, with the at least one processor, cause the apparatus to at least maintain, by a first router for a communication link between a first interface of the first router and a second interface of a second router, flooding control information including a first indication as to whether flooding of link state information via the first interface of the first router is to be supported and a second indication as to whether flooding of link state information via the second interface of the second router is to be supported. In at least some example embodiments, the at least one memory and the computer program code are configured to, with the at least one processor, cause the apparatus to at least send, from the first router toward the second router via the first interface of the first router, the first indication as to whether flooding of link-state information via the first interface is to be supported. In at least some example embodiments, the first indication as to whether flooding of link-state information via the first interface is to be supported is sent using an adjacency message or a link state message. In at least some example embodiments, the first indication as to whether flooding of link-state information via the first interface is to be supported is provided by sending a message without including a particular type-length-value (TLV). In at least some example embodiments, the sending of the message without including the particular TLV is indicative that flooding of link-state information via the first interface is to be supported. In at least some example embodiments, the first indication as to whether flooding of link-state information via the first interface is to be supported is provided using a TLV. In at least some example embodiments, the TLV includes a field configured to support a first value indicative that flooding of link-state information via the first interface is to be supported and a second value indicative that flooding of link-state information via the first interface is not to be supported. In at least some example embodiments, the first indication as to whether flooding of link-state information via the first interface is to be supported is sent based on a path computation performed by the first node for reaching an anchor node of a link-state flooding topology. In at least some example embodiments, based on a determination that the first interface is identified as part of a path toward the anchor node, the first indication as to whether flooding of link-state information via the first interface is to be supported includes an indication that flooding of link-state information via the first interface is to be supported. In at least some example embodiments, based on a determination that the first interface is not identified as part of a path toward the anchor node, the first indication as to whether flooding of link-state information via the first interface is to be supported includes an indication that flooding of link-state information via the first interface is not to be supported. In at least some example embodiments, the anchor node is identified based on receipt of a message including an indication of the anchor node. In at least some example embodiments, the first indication as to whether flooding of link-state information via the first interface is to be supported is sent based on booting of the first router, based on establishment of an adjacency between the first router and the second router, based on a determination that a particular amount of link-state information has been received by the first router, or based on a periodic determination to send an adjacency message from the first router to the second router. In at least some example embodiments, the at least one memory and the computer program code are configured to, with the at least one processor, cause the apparatus to at least receive, at a first router from a second router via the first interface of the first router, the second indication as to whether flooding of link-state information via the second interface of the second router is to be supported. In at least some example embodiments, the second indication as to whether flooding of link-state information via the second interface is to be supported is received via an adjacency message or a link state message. In at least some example embodiments, the second indication as to whether flooding of link-state information via the second interface is to be supported is determined based on absence of a particular TLV in a message. In at least some example embodiments, the second indication as to whether flooding of link-state information via the second interface is to be supported is determined based on inclusion of a particular TLV in the message. In at least some example embodiments, the at least one memory and the computer program code are configured to, with the at least one processor, cause the apparatus to at least receive, by the first router, link-state information and determine, by the first router based on the first indication and the second indication, whether to flood the link-state information over the first interface. In at least some example embodiments, the at least one memory and the computer program code are configured to, with the at least one processor, cause the apparatus to at least initiate flooding of link-state information via the first interface based on at least one of a determination that flooding of link-state information via the first interface is to be supported or a determination that flooding of link-state information via the second interface is to be supported. In at least some example embodiments, the at least one memory and the computer program code are configured to, with the at least one processor, cause the apparatus to at least prevent flooding of link-state information via the interface based on a determination that flooding of link-state information via the first interface is not to be supported and a determination that flooding of link-state information via the second interface is not to be supported.

In at least some example embodiments, a non-transitory computer-readable medium includes instructions configured to cause an apparatus to at least maintain, by a first router for a communication link between a first interface of the first router and a second interface of a second router, flooding control information including a first indication as to whether flooding of link state information via the first interface of the first router is to be supported and a second indication as to whether flooding of link state information via the second interface of the second router is to be supported. In at least some example embodiments, the non-transitory computer-readable medium includes instructions configured to cause the apparatus to at least send, from the first router toward the second router via the first interface of the first router, the first indication as to whether flooding of link-state information via the first interface is to be supported. In at least some example embodiments, the first indication as to whether flooding of link-state information via the first interface is to be supported is sent using an adjacency message or a link state message. In at least some example embodiments, the first indication as to whether flooding of link-state information via the first interface is to be supported is provided by sending a message without including a particular type-length-value (TLV). In at least some example embodiments, the sending of the message without including the particular TLV is indicative that flooding of link-state information via the first interface is to be supported. In at least some example embodiments, the first indication as to whether flooding of link-state information via the first interface is to be supported is provided using a TLV. In at least some example embodiments, the TLV includes a field configured to support a first value indicative that flooding of link-state information via the first interface is to be supported and a second value indicative that flooding of link-state information via the first interface is not to be supported. In at least some example embodiments, the first indication as to whether flooding of link-state information via the first interface is to be supported is sent based on a path computation performed by the first node for reaching an anchor node of a link-state flooding topology. In at least some example embodiments, based on a determination that the first interface is identified as part of a path toward the anchor node, the first indication as to whether flooding of link-state information via the first interface is to be supported includes an indication that flooding of link-state information via the first interface is to be supported. In at least some example embodiments, based on a determination that the first interface is not identified as part of a path toward the anchor node, the first indication as to whether flooding of link-state information via the first interface is to be supported includes an indication that flooding of link-state information via the first interface is not to be supported. In at least some example embodiments, the anchor node is identified based on receipt of a message including an indication of the anchor node. In at least some example embodiments, the first indication as to whether flooding of link-state information via the first interface is to be supported is sent based on booting of the first router, based on establishment of an adjacency between the first router and the second router, based on a determination that a particular amount of link-state information has been received by the first router, or based on a periodic determination to send an adjacency message from the first router to the second router. In at least some example embodiments, the non-transitory computer-readable medium includes instructions configured to cause the apparatus to at least receive, at a first router from a second router via the first interface of the first router, the second indication as to whether flooding of link-state information via the second interface of the second router is to be supported. In at least some example embodiments, the second indication as to whether flooding of link-state information via the second interface is to be supported is received via an adjacency message or a link state message. In at least some example embodiments, the second indication as to whether flooding of link-state information via the second interface is to be supported is determined based on absence of a particular TLV in a message. In at least some example embodiments, the second indication as to whether flooding of link-state information via the second interface is to be supported is determined based on inclusion of a particular TLV in the message. In at least some example embodiments, the non-transitory computer-readable medium includes instructions configured to cause the apparatus to at least receive, by the first router, link-state information and determine, by the first router based on the first indication and the second indication, whether to flood the link-state information over the first interface. In at least some example embodiments, the non-transitory computer-readable medium includes instructions configured to cause the apparatus to at least initiate flooding of link-state information via the first interface based on at least one of a determination that flooding of link-state information via the first interface is to be supported or a determination that flooding of link-state information via the second interface is to be supported. In at least some example embodiments, the non-transitory computer-readable medium includes instructions configured to cause the apparatus to at least prevent flooding of link-state information via the interface based on a determination that flooding of link-state information via the first interface is not to be supported and a determination that flooding of link-state information via the second interface is not to be supported.

In at least some example embodiments, a method includes maintaining, by a first router for a communication link between a first interface of the first router and a second interface of a second router, flooding control information including a first indication as to whether flooding of link state information via the first interface of the first router is to be supported and a second indication as to whether flooding of link state information via the second interface of the second router is to be supported. In at least some example embodiments, the method includes sending, from the first router toward the second router via the first interface of the first router, the first indication as to whether flooding of link-state information via the first interface is to be supported. In at least some example embodiments, the first indication as to whether flooding of link-state information via the first interface is to be supported is sent using an adjacency message or a link state message. In at least some example embodiments, the first indication as to whether flooding of link-state information via the first interface is to be supported is provided by sending a message without including a particular type-length-value (TLV). In at least some example embodiments, the sending of the message without including the particular TLV is indicative that flooding of link-state information via the first interface is to be supported. In at least some example embodiments, the first indication as to whether flooding of link-state information via the first interface is to be supported is provided using a TLV. In at least some example embodiments, the TLV includes a field configured to support a first value indicative that flooding of link-state information via the first interface is to be supported and a second value indicative that flooding of link-state information via the first interface is not to be supported. In at least some example embodiments, the first indication as to whether flooding of link-state information via the first interface is to be supported is sent based on a path computation performed by the first node for reaching an anchor node of a link-state flooding topology. In at least some example embodiments, based on a determination that the first interface is identified as part of a path toward the anchor node, the first indication as to whether flooding of link-state information via the first interface is to be supported includes an indication that flooding of link-state information via the first interface is to be supported. In at least some example embodiments, based on a determination that the first interface is not identified as part of a path toward the anchor node, the first indication as to whether flooding of link-state information via the first interface is to be supported includes an indication that flooding of link-state information via the first interface is not to be supported. In at least some example embodiments, the anchor node is identified based on receipt of a message including an indication of the anchor node. In at least some example embodiments, the first indication as to whether flooding of link-state information via the first interface is to be supported is sent based on booting of the first router, based on establishment of an adjacency between the first router and the second router, based on a determination that a particular amount of link-state information has been received by the first router, or based on a periodic determination to send an adjacency message from the first router to the second router. In at least some example embodiments, the method includes receiving, at a first router from a second router via the first interface of the first router, the second indication as to whether flooding of link-state information via the second interface of the second router is to be supported. In at least some example embodiments, the second indication as to whether flooding of link-state information via the second interface is to be supported is received via an adjacency message or a link state message. In at least some example embodiments, the second indication as to whether flooding of link-state information via the second interface is to be supported is determined based on absence of a particular TLV in a message. In at least some example embodiments, the second indication as to whether flooding of link-state information via the second interface is to be supported is determined based on inclusion of a particular TLV in the message. In at least some example embodiments, the method includes receiving, by the first router, link-state information and determining, by the first router based on the first indication and the second indication, whether to flood the link-state information over the first interface. In at least some example embodiments, the method includes initiating flooding of link-state information via the first interface based on at least one of a determination that flooding of link-state information via the first interface is to be supported or a determination that flooding of link-state information via the second interface is to be supported. In at least some example embodiments, the method includes preventing flooding of link-state information via the interface based on a determination that flooding of link-state information via the first interface is not to be supported and a determination that flooding of link-state information via the second interface is not to be supported.

In at least some example embodiments, an apparatus includes means for maintaining, by a first router for a communication link between a first interface of the first router and a second interface of a second router, flooding control information including a first indication as to whether flooding of link state information via the first interface of the first router is to be supported and a second indication as to whether flooding of link state information via the second interface of the second router is to be supported. In at least some example embodiments, the apparatus includes means for sending, from the first router toward the second router via the first interface of the first router, the first indication as to whether flooding of link-state information via the first interface is to be supported. In at least some example embodiments, the first indication as to whether flooding of link-state information via the first interface is to be supported is sent using an adjacency message or a link state message. In at least some example embodiments, the first indication as to whether flooding of link-state information via the first interface is to be supported is provided by sending a message without including a particular type-length-value (TLV). In at least some example embodiments, the sending of the message without including the particular TLV is indicative that flooding of link-state information via the first interface is to be supported. In at least some example embodiments, the first indication as to whether flooding of link-state information via the first interface is to be supported is provided using a TLV. In at least some example embodiments, the TLV includes a field configured to support a first value indicative that flooding of link-state information via the first interface is to be supported and a second value indicative that flooding of link-state information via the first interface is not to be supported. In at least some example embodiments, the first indication as to whether flooding of link-state information via the first interface is to be supported is sent based on a path computation performed by the first node for reaching an anchor node of a link-state flooding topology. In at least some example embodiments, based on a determination that the first interface is identified as part of a path toward the anchor node, the first indication as to whether flooding of link-state information via the first interface is to be supported includes an indication that flooding of link-state information via the first interface is to be supported. In at least some example embodiments, based on a determination that the first interface is not identified as part of a path toward the anchor node, the first indication as to whether flooding of link-state information via the first interface is to be supported includes an indication that flooding of link-state information via the first interface is not to be supported. In at least some example embodiments, the anchor node is identified based on receipt of a message including an indication of the anchor node. In at least some example embodiments, the first indication as to whether flooding of link-state information via the first interface is to be supported is sent based on booting of the first router, based on establishment of an adjacency between the first router and the second router, based on a determination that a particular amount of link-state information has been received by the first router, or based on a periodic determination to send an adjacency message from the first router to the second router. In at least some example embodiments, the apparatus includes means for receiving, at a first router from a second router via the first interface of the first router, the second indication as to whether flooding of link-state information via the second interface of the second router is to be supported. In at least some example embodiments, the second indication as to whether flooding of link-state information via the second interface is to be supported is received via an adjacency message or a link state message. In at least some example embodiments, the second indication as to whether flooding of link-state information via the second interface is to be supported is determined based on absence of a particular TLV in a message. In at least some example embodiments, the second indication as to whether flooding of link-state information via the second interface is to be supported is determined based on inclusion of a particular TLV in the message. In at least some example embodiments, the apparatus includes means for receiving, by the first router, link-state information and means for determining, by the first router based on the first indication and the second indication, whether to flood the link-state information over the first interface. In at least some example embodiments, the apparatus includes means for initiating flooding of link-state information via the first interface based on at least one of a determination that flooding of link-state information via the first interface is to be supported or a determination that flooding of link-state information via the second interface is to be supported. In at least some example embodiments, the apparatus includes means for preventing flooding of link-state information via the interface based on a determination that flooding of link-state information via the first interface is not to be supported and a determination that flooding of link-state information via the second interface is not to be supported.

In at least some example embodiments, an apparatus includes at least one processor and at least one memory including computer program code, wherein the at least one memory and the computer program code are configured to, with the at least one processor, cause the apparatus to at least send, by a router of a link-state information flooding topology based on a determination that the router is an anchor node for the link-state information flooding topology, a message including an indication that the router is the anchor node for the link-state information flooding topology. In at least some example embodiments, a non-transitory computer-readable medium includes instructions configured to cause an apparatus to at least send, by a router of a link-state information flooding topology based on a determination that the router is an anchor node for the link-state information flooding topology, a message including an indication that the router is the anchor node for the link-state information flooding topology. In at least some example embodiments, a method includes sending, by a router of a link-state information flooding topology based on a determination that the router is an anchor node for the link-state information flooding topology, a message including an indication that the router is the anchor node for the link-state information flooding topology. In at least some example embodiments, an apparatus includes means for sending, by a router of a link-state information flooding topology based on a determination that the router is an anchor node for the link-state information flooding topology, a message including an indication that the router is the anchor node for the link-state information flooding topology.

### BRIEF DESCRIPTION OF THE DRAWINGS

The teachings herein can be readily understood by considering the following detailed description in conjunction with the accompanying drawings, in which:

FIG. 1 depicts an example embodiment of a communication system including routers configured to support sparse link-state flooding for routing protocols;

FIG. 2 depicts the communication system of FIG. 1, in which one of the routers has been configured to be the anchor node for the sparse link-state flooding topology;

FIG. 3 depicts the communication system of FIG. 2, in which one of the routers has clamped onto the sparse link-state flooding topology;

FIG. 4 depicts the communication system of FIG. 3, in which each of the routers has clamped onto the sparse link-state flooding topology and the routers have exchanged flooding control information to provide the sparse link-state flooding topology;

FIG. 5 depicts the communication system of FIG. 4, in which the sparse link-state flooding topology established based on the anchor node has been supplemented with a second sparse link-state flooding topology established based on a second anchor node;

FIG. 6 depicts an example embodiment of a method for use by an anchor node for supporting establishment of a sparse link-state flooding topology;

FIG. 7 depicts an example embodiment of a method for use by a router to send flooding control information for supporting establishment of a sparse link-state flooding topology;

FIG. 8 depicts an example embodiment of a method for use by a router to receive flooding control information for supporting establishment of a sparse link-state flooding topology;

FIG. 9 depicts an example embodiment of a method for use by a router to support establishment and use of a sparse link-state flooding topology; and

FIG. 10 depicts a high-level block diagram of a computer suitable for use in performing various functions presented herein.

To facilitate understanding, identical reference numerals have been used, where possible, to designate identical elements that are common to the figures.

### DETAILED DESCRIPTION

Various example embodiments for supporting link-state flooding for routing protocols are presented. Various example embodiments for supporting link-state flooding for a routing protocol may be configured to support sparse link-state flooding for the routing protocol. Various example embodiments for supporting sparse link-state flooding for a routing protocol may be configured to support sparse link-state flooding for the routing protocol by supporting distributed establishment of a sparse link-state flooding topology for the routing protocol. Various example embodiments for supporting sparse link-state flooding for a routing protocol may be configured to support distributed establishment of a sparse link-state flooding topology for the routing protocol based on enabling routers to identify and clamp onto the sparse link-state flooding topology for the routing protocol. Various example embodiments for supporting sparse link-state flooding for a routing protocol may be configured to support distributed establishment of a sparse link-state flooding topology for the routing protocol based on establishment of an anchor node for the sparse link-state flooding topology and based on enabling routers to identify and clamp onto the sparse link-state flooding topology based on identification of paths from the routers to the anchor node for the sparse link-state flooding topology and setting of flooding control information for interfaces of the routers based on the paths from the routers to the anchor node for the sparse link-state flooding topology. Various example embodiments for supporting sparse link-state flooding for a routing protocol may be configured to support distributed establishment of a sparse link-state flooding topology for the routing protocol based on exchanging of flooding control information by the routers and based on maintaining of flooding control information by the routers (including local flooding control information of the routers that is determined at the routers and neighbor flooding control information of adjacent routers that is received by the routers based on the exchanging of flooding control information by the routers). Various example embodiments for supporting sparse link-state flooding for a routing protocol may be configured to support sparse link-state flooding using flooding control information at the routers to flood link-state information over a sparse link-state flooding topology indicated by the flooding control information. Various example embodiments for supporting sparse link-state flooding for a routing protocol may be configured to support sparse link-state flooding for the routing protocol in various types of networks (e.g., communication networks such as operator networks, highly resilient networks such as datacenter networks, or the like) using various types of network topologies (e.g., full or partial mesh, spine-and-leaf, ring, dense or sparse, or the like, as well as various combinations thereof) and various types of associated capabilities (e.g., resilient links, multipath technologies such as equal-cost multipath (ECMP), or the like, as well as various combinations thereof). It will be appreciated that these and various other example embodiments and advantages of supporting sparse link-state flooding for routing protocols may be further understood by way of reference to the various figures, which are discussed further below.

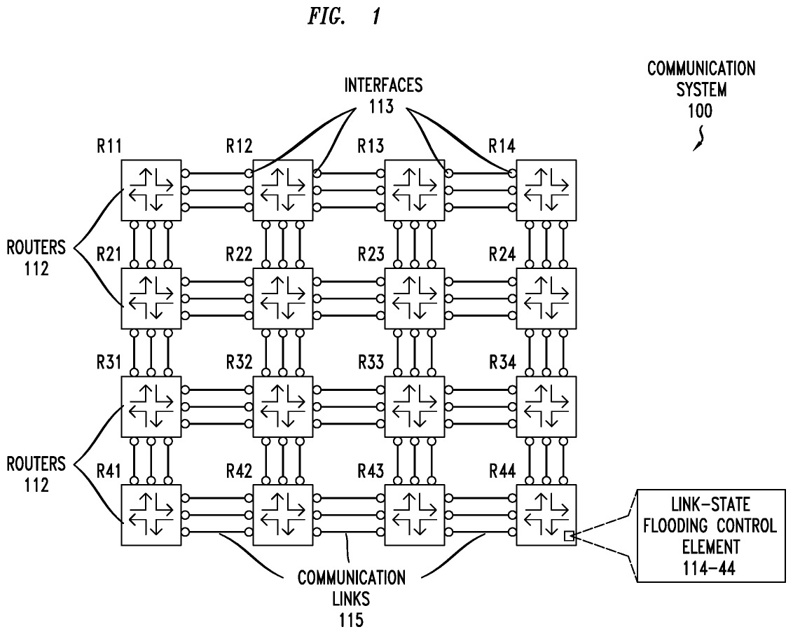

FIG. 1 depicts an example embodiment of a communication system including routers configured to support sparse link-state flooding for routing protocols.

The communication system 100 includes a set of routers 112 (including sets of interfaces 113, respectively) and a set of communication links 115 configured to connect the routers 112 for supporting communications between the routers 112 (supporting communications between pairs of interfaces 113 on adjacent routers 112). As illustrated in FIG. 1, the set of routers 112 includes sixteen routers 112 which are arranged in a four-by-four grid (and which, for purposes of clarity, also are numbered using the convention Rxy, where x (1 . . . 4) denotes the row of the grid and y (1 . . . 4) denotes the column of the grid). As illustrated in FIG. 1, each router 112 is connected to each of its neighboring routers 112 via three communication links 115, respectively. In general, the communication link 115 between a pair of neighboring routers 112 including a first router 112-x and a second router 112-y connects an interface 113-x on the first router 112-x with an interface 113-y on the second router 112-y. It will be appreciated that, although primarily presented with respect to a communication system having specific types, numbers, and arrangements of elements (namely, routers 112, interfaces 113, and communication links 115), the communication system may include various other types, numbers, and arrangements of elements.

The communication system 100 is configured to support link-state flooding for a routing protocol. The routers 112 may be configured to maintain and exchange link-state information of the routing protocol. The link-state information that is maintained and flooded by the routers 112 may be maintained using link state databases (LSDBs) on the routers 112 (which have been omitted for purposes of clarity). The routing protocol for which link-state flooding is supported may be any routing protocol which may be used to flood link-state information, such as an Interior Gateway Protocol (e.g., Intermediate-System-to-Intermediate-System (IS-IS), Open Shortest Path First (OSPF), or the like), an Exterior Gateway Protocol, or the like. The link-state information that is flooded may be flooded using various types of messages which may vary across various routing protocols (e.g., link state packets (LSPs) in IS-IS, link state advertisements (LSAs) in OSPF, or the like). It will be appreciated that, although primarily presented with respect to use of a single routing protocol, multiple routing protocols may be active within the communication system 100.

The communication system 100 is configured to support sparse link-state flooding for a routing protocol. The communication system 100 may be configured to support sparse link-state flooding for a routing protocol based on support for distributed establishment of a sparse link-state flooding topology for the routing protocol. The distributed establishment of the sparse link-state flooding topology may be based on use of an anchor node for the sparse link-state flooding topology that the routers 112 know is part of the sparse link-state flooding topology and, thus, that the routers 112 can use as a reference for attaching to the sparse link-state flooding topology. The distributed establishment of the sparse link-state flooding topology may be based on capabilities for enabling the routers 112 to identify the anchor node for the sparse link-state flooding topology and for enabling the routers 112 clamp onto the sparse link-state flooding topology based on the anchor node for the sparse link-state flooding topology. The distributed establishment of the sparse link-state flooding topology may be based on setting of flooding control information for the interfaces 113 of communication links 115 connecting adjacent routers 112 (e.g., setting each interface 113 to a “do flood” state or a “do not flood” state, based on various types of information and under various conditions, to enable the routers 112 to clamp onto the sparse link-state flooding topology) and based on exchanging of the flooding control information for the interfaces 113 of communication links 115 connecting adjacent routers 112 between the routers 112 based on the routing protocol. It will be appreciated that the sparse link-state flooding may be supported for various routing protocols which may be used to flood link-state information (e.g., IS-IS, OSPF, or the like).

The communication system 100, as indicated above, is configured to support sparse link-state flooding for a routing protocol. The routers 112 each include a link-state flooding control element 114, respectively, configured to support various functions supporting sparse link-state flooding for a routing protocol (although it is noted that, for purposes of clarity, only one of the link-state flooding control elements 114, associated with router R44, is illustrated in FIG. 1). For example, the link-state flooding control elements 114 may be configured to support distributed establishment of a sparse link-state flooding topology for a routing protocol and use of the link-state flooding topology for the routing protocol to flood link-state information. For example, the link-state flooding control elements 114 may be configured to support distributed establishment of a sparse link-state flooding topology by supporting functions associated with establishment of an anchor node for the sparse link-state flooding topology, supporting functions for enabling routers 112 to clamp onto the sparse link-state flooding topology based on the anchor node for the sparse link-state flooding topology (e.g., identification of the anchor node for the sparse link-state flooding topology, computation of paths to the anchor node for the sparse link-state flooding topology, setting of flooding control information of interfaces 113, or the like), supporting functions for enabling routers 112 to exchange flooding control information for the sparse link-state flooding topology, or the like, as well as various combinations thereof. It is noted that the link-state flooding control elements 114 of the routers 112 may be configured to support various other functions for supporting sparse link-state flooding for a routing protocol.

The distributed establishment of the sparse link-state flooding topology, as indicated above, is based on use of an anchor node for the sparse link-state flooding topology. The anchor node for the sparse link-state flooding topology provides an anchor, or reference, point which the other routers 112 may use as a basis for clamping onto the sparse link-state flooding topology. The distributed establishment of the sparse link-state flooding topology may include establishing the anchor node for the sparse link-state flooding topology and establishing the sparse link-state flooding topology based on the anchor node for the sparse link-state flooding topology. The establishment of the sparse link-state flooding topology based on the anchor node for the sparse link-state flooding topology may include enabling the routers 112 to clamp onto the sparse link-state flooding topology based on the anchor node for the sparse link-state flooding topology (e.g., where each router 112 may clamp onto the sparse link-state flooding topology by identifying the anchor node for sparse link-state flooding topology and using identification of the anchor node for the sparse link-state flooding topology to clamp onto the sparse link-state flooding topology based on computation of a path to the anchor node for the sparse link-state flooding topology and setting of flooding control information of interfaces 113 based on the path to the anchor node for the sparse link-state flooding topology) and enabling the routers 112 to exchange the flooding control information of the interfaces 113. In this manner, the routers 112 set and learn flooding control information for the interfaces 113 which results in the sparse link-state flooding topology which may then be used by the routers 112 for improved flooding of link-state information by the associated routing protocol.

The anchor node for the sparse link-state flooding topology may be established in various ways.

In at least some embodiments, for example, one of the routers 112 may be configured to be the anchor node for the sparse link-state flooding topology. The router 112 that is configured to be the anchor node may be selected and configured manually (e.g., by a user via an interface of a network management system), automatically (e.g., by a network management system), or the like.

In at least some embodiments, for example, one of the routers 112 may be elected to be the anchor node for the sparse link-state flooding topology. The router 112 that is elected to be the anchor node may be elected based on a distributed process in which the routers 112 exchange information which may be used for electing one of the routers 112 to be the anchor node for the sparse link-state flooding topology (e.g., information is exchange until each of the routers 112 ultimately agrees on the one of the routers 112 to be the anchor node for the sparse link-state flooding topology).

In at least some embodiments, for example, one of the routers 112 may be selected to be the anchor node for the sparse link-state flooding topology. The router 112 that is selected to be the anchor node may be selected based on a distributed process in which the routers 112 are configured to use a set of rules for selecting one of the routers 112 to be the anchor node for the sparse link-state flooding topology and in which the set of rules is configured such that each of the routers 112 ultimately selects the same one of the routers 112 to be the anchor node for the sparse link-state flooding topology (e.g., a rule that is based on the router identifiers of the routers 112 (e.g., a router with the highest router identifier or lowest router identifier), a rule that is based on the tiers of the routers 112 (e.g., a highest tier router), a rule that is based on the IP addresses of the routers 112 (e.g., a highest IP address), or the like, as well as various combinations thereof).

The anchor node for the sparse link-state flooding topology, once established, sets each of its interfaces 113 to a “do not flood” state. It will be appreciated that this operation may be performed at various times, depending on the manner in which the one of the routers 112 that assumes the role of the anchor node for the sparse link-state flooding topology is configured to be the anchor node for the sparse link-state flooding topology.

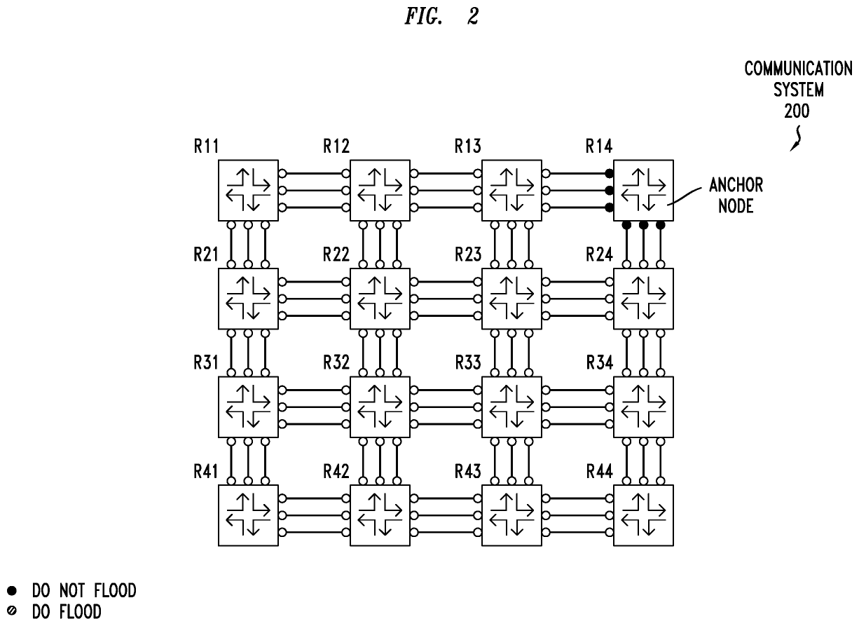

The configuration of one of the routers 112 to be the anchor node for the sparse link-state flooding topology and the associated configuration of the interfaces 113 of the one of the routers 112 based on its configuration as the anchor node for the sparse link-state flooding topology may be further understood by way of reference to FIG. 2. FIG. 2 depicts a communication system 200, which is based on the communication system 100 of FIG. 1, in which one of the routers 112 has been configured to be the anchor node for the sparse link-state flooding topology. As depicted in FIG. 2, router R14 is the anchor node for the sparse link-state flooding topology that will be established and, thus, router R14 sets the flooding control information for its interfaces 113 based on a determination that it is the anchor node for the sparse link-state flooding topology that will be established (illustratively, its three interfaces with router R13 have been set to the “do not flood” state, and, similarly, its three interfaces with router R24 have been set to the “do not flood” state).

It will be appreciated that the anchor node for the sparse link-state flooding topology may be established in various other ways.

The routers 112 may identify the anchor node for the sparse link-state flooding topology in various ways, at least some of which may depend on the manner in which the anchor node is set for the sparse link-state flooding topology.

In at least some embodiments, the anchor node of the sparse link-state flooding topology may be identified based on advertisements sent by the anchor node. The router 112 that is the anchor node may send advertisements over its various interfaces where the advertisements may include an indication that the router 112 is the anchor node for the sparse link-state flooding topology. In at least some embodiments in which IS-IS is the routing protocol, the indication that the router 112 is the anchor node may be provided using a type-length-value (TLV) in an LSP, such as an anchor TLV or an anchor sub-TLV. In at least some embodiments in which OSPF is the routing protocol, the indication that the router 112 is the anchor node may be provided using an indicator in an LSA, an indicator in an opaque LSA, or the like. It will be appreciated that the indication that the router 112 is the anchor node may be provided in various other ways.

In at least some embodiments, for example, the anchor node of the sparse link-state flooding topology may be identified based on exchanging of messages by the routers 112 for electing the anchor node for the sparse link-state flooding topology. For example, information may be exchange until each of the routers 112 ultimately agrees on the one of the routers 112 to be the anchor node for the sparse link-state flooding topology.

In at least some embodiments, the anchor node of the sparse link-state flooding topology may be identified based on use of rules used by the routers 112 for selecting the anchor node for the sparse link-state flooding topology. For example, the routers 112 may be configured with a set of rules configured such that each of the routers 112 ultimately selects the same one of the routers 112 to be the anchor node for the sparse link-state flooding topology (e.g., a rule that is based on the router identifiers of the routers 112 (e.g., a router with the highest router identifier or lowest router identifier), a rule that is based on the tiers of the routers 112 (e.g., a highest tier router), a rule that is based on the IP addresses of the routers 112 (e.g., a highest IP address), or the like, as well as various combinations thereof).

It will be appreciated that the routers 112 may determine the identity of the anchor node for the sparse link-state flooding topology in various other ways.

The routers 112 may use identification of the anchor node for the sparse link-state flooding topology to clamp onto the sparse link-state flooding topology in various ways (e.g., based on computation of a path to the anchor node for the sparse link-state flooding topology and setting of flooding control information of interfaces 113 based on the path to the anchor node for the sparse link-state flooding topology).

A router 112 may use identification of the anchor node for the sparse link-state flooding topology to compute a path from the router 112 to the anchor node for the sparse link-state flooding topology. The router 112 may compute the path to the anchor node for the sparse link-state flooding topology using a Shortest Path First (SPF) algorithm (e.g., Dijkstra's algorithm or other suitable SPF algorithm) or other suitable algorithm or process for computing a path to the anchor node for the sparse link-state flooding topology. The router 112, based on identification of multiple potential paths to the anchor node for the sparse link-state flooding topology (e.g., where Equal-Cost Multi-Path (ECMP) routing or other multipath routing technologies are used), may select one of the multiple potential paths as the path to the anchor node for the sparse link-state flooding topology.

A router 112 may use the path to the anchor node for the sparse link-state flooding topology for setting flooding control information of interfaces 113 of the router 112. A router 112 that identifies a path to the anchor node for the sparse link-state flooding topology may set its interface 113 associated with the path to the anchor node for the sparse link-state flooding topology to the “do flood” state and may set each of its other interfaces 113 which are not associated with the path to the anchor node for the sparse link-state flooding topology to the “do not flood” state.

It will be appreciated that the routers 112 may use identification of the anchor node for the sparse link-state flooding topology to clamp onto the sparse link-state flooding topology in various other ways.

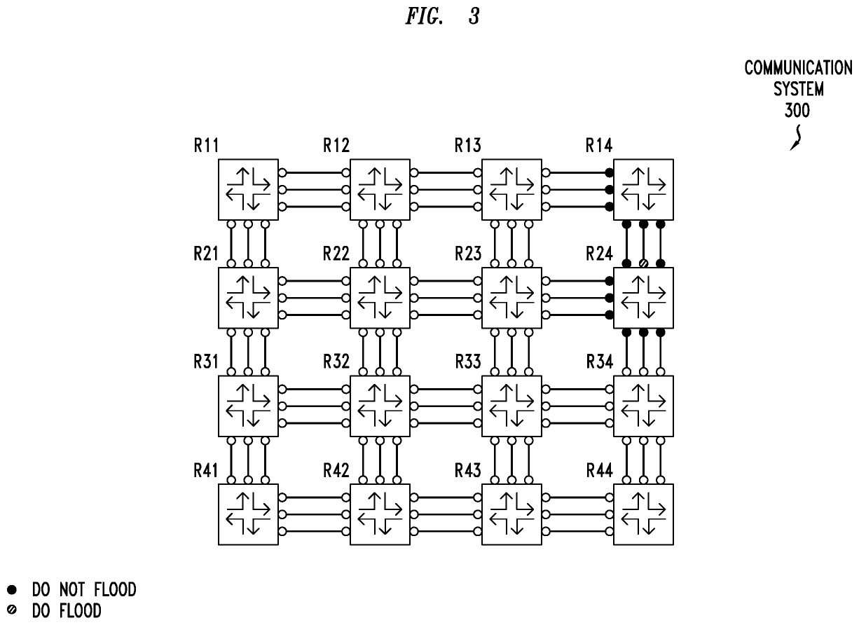

The functions performed by a router 112 to determine the identity of the anchor node for the sparse link-state flooding topology to clamp onto the sparse link-state flooding topology based on identification of the anchor node for the sparse link-state flooding topology may be further understood by way of reference to FIG. 3. FIG. 3 depicts a communication system 300, which is based on the communication system 200 of FIG. 2, in which one of the routers 112 has clamped onto the sparse link-state flooding topology. As depicted in FIG. 3, router R24 has determined that router R14 is the anchor node for the sparse link-state flooding topology, has computed a path to the router R14 that is the anchor node for the sparse link-state flooding topology (illustratively, over the middle communication link 115 between router R24 and router R14), and has set the flooding control information for its interfaces 113 based on the path to the router R14 that is the anchor node for the sparse link-state flooding topology (illustratively, its interface 113 associated with the path to the router R14 for the sparse link-state flooding topology has been set to the “do flood” state, its other two interfaces associated with different paths to the router R14 which were not selected for the sparse link-state flooding topology have been set to the “do not flood” state, its three interfaces with router R23 have been set to the “do not flood” state, its three interfaces with router R34 have been set to the “do not flood” state).

It will be appreciated that the routers 112 may identify the anchor node for the sparse link-state flooding topology in various other ways and, similarly, may clamp onto the sparse link-state flooding topology in various other ways.

The routers 112 exchange the flooding control information of the interfaces 113 and maintain flooding control information of the interfaces 113 to provide the sparse link-state flooding topology which may then be used by the routers 112 for improved flooding of link-state information by the associated routing protocol. The routers 112 may exchange the flooding control information of the interfaces 113 and maintain flooding control information of the interfaces 113 with adjacent routers 112. The exchanging of the flooding control information of the interfaces 113 includes processing performed by routers 112 for determining flooding control information of their interfaces 113 and sending the flooding control information of the their interfaces 113 to adjacent routers 112 and processing performed by routers 112 for receiving flooding control information of interfaces 113 from adjacent routers 112 and handling the flooding control information of the interfaces 113 from the adjacent routers 112. The routers 112 may then maintain a combination of the local flooding control information of their own interfaces 113 and flooding control information of interfaces 113 of adjacent routers 112 to provide the sparse link-state flooding topology which may then be used by the routers 112 for improved flooding of link-state information by the associated routing protocol.

The routers 112 may send the flooding control information of their interfaces 113 to adjacent routers 112 in various ways, which may depend on the routing protocol for which the sparse link-state flooding topology is established.

The routers 112 may send the flooding control information of their interfaces 113 to adjacent routers 112 using various message types, various indicator types, various indicators, or the like, as well as various combinations thereof. For example, the routers 112 may send the flooding control information of their interfaces 113 to adjacent routers 112 using various message types, such as adjacency messages configured for use in establishing or maintaining adjacencies between adjacent routers 112 (e.g., hello messages or other suitable types of adjacency messages), link state messages configured to support transport of link-state information between routers 112 (e.g., LSPs, LSAs, or the like), or the like, as well as various combinations thereof. For example, the routers 112 may send the flooding control information of their interfaces 113 to adjacent routers 112 using various indicator types (e.g., using an existing or new TLV, using one or more existing fields, using one or more new fields, or the like, as well as various combinations thereof). For example, the routers 112 may send the flooding control information of their interfaces 113 to adjacent routers 112 using various indicators (e.g., absence of a particular indicator type means “do not flood” or “do flood”, presence of a particular indicator type or associated value means “do not flood” or “do flood”, or the like). It will be appreciated that other message types, indicator types, or indicators may be used.

In at least some embodiments, for example, where the routing protocol is IS-IS, the flooding control information may be sent within IS-IS Hello (IIH) messages.

In at least some embodiments, the flooding control information may be sent within IIH messages using a newly defined TLV.

For example, the newly defined TLV for IIH messages may be a DoNotFlood (DNF) TLV, which may be configured such that absence of the DNF TLV from an IIH message for a particular interface 113 indicates that the flooding state of the interface 113 is “do flood”, presence of the DNF TLV within an IIH message for a particular interface 113 with a FALSE indicator or value (e.g., “0” or the like) indicates that the flooding state of the interface 113 is “do flood”, and presence of the DNF TLV within an IIH message for a particular interface 113 with a TRUE indicator or value (e.g., “1” or the like) indicates that the flooding state of the interface 113 is “do not flood”. It is noted that use of a DNF TLV enables backwards compatibility with protocols in which full flooding is performed (e.g., in which the default state is that link-state information is flooded over each interface).

For example, the newly defined TLV for IIH messages may be a DoFlood (DF) TLV, which may be configured such that absence of the DF TLV from an IIH message for a particular interface 113 indicates that the flooding state of the interface 113 is “do flood”, presence of the DF TLV within an IIH message for a particular interface 113 with a FALSE indicator or value (e.g., “0” or the like) indicates that the flooding state of the interface 113 is “do not flood”, and presence of the DF TLV within an IIH message for a particular interface 113 with a TRUE indicator or value (e.g., “1” or the like) indicates that the flooding state of the interface 113 is “do flood”.

In at least some embodiments, for example, where the routing protocol is OSPF, the flooding control information may be sent within OSPF Hello messages, OSPF LSAs, OSPF Opaque LSAs, or the like, as well as various combinations thereof.

The routers 112 may send the flooding control information of the interfaces 113 to adjacent routers 112 in response to various events or conditions.

For example, a router 112 may send flooding control information of at least some of its interfaces 113 with adjacent routers 112 to those adjacent routers 112 when the router 112 boots up (e.g., as part of an adjacency establishment period in which the router 112 identifies adjacent routers 112 and establishes adjacencies with the adjacent routers 112).

For example, a router 112 may send flooding control information of at least some of its interfaces 113 with adjacent routers 112 to those adjacent routers 112 based on a determination by the router 112 that it has received the full LSDB from the adjacent routers 112, based on a determination by the router 112 that it has received a threshold portion of the LSDB from the adjacent routers 112, based on a determination by the router 112 that it has probably received the full LSDB or at least a threshold portion of the LSDB from the adjacent routers 112 (e.g., based on an amount of time that has elapsed since booting), or the like, as well as various combinations thereof.

For example, a router 112 may send flooding control information of at least some of its interfaces 113 with adjacent routers 112 to those adjacent routers 112 after performing a path computation (e.g., an SPF computation for identifying a path to the anchor node of the sparse link-state flooding topology, an SPF computation performed for a purpose other than identifying a path to the anchor node of the sparse link-state flooding topology, or the like, as well as various combinations thereof).

For example, a router 112 may send flooding control information of at least some of its interfaces 113 with adjacent routers 112 to those adjacent routers 112 periodically (e.g., as part of a periodic adjacency maintenance process in which neighboring routers 112 exchange adjacency messages (e.g., hello messages or the like) periodically for maintaining adjacencies and detecting problems associated with communications between adjacent routers 112).

For example, a router 112 may send flooding control information of at least some of its interfaces 113 with adjacent routers 112 to those adjacent routers 112 when the flooding control information changes (e.g., based on topology changes, failures, or the like). For example, if a router 112 changes the flooding control state of an interface 113 associated with a communication link 115 to an adjacent router 112 (e.g., from “do not flood” to “do flood” or from “do flood” to “do not flood”), the router 112 may send flooding control information indicative of the change to the flooding control state of the interface 113 associated with the communication link 115 to the adjacent router 112.

For example, a router 112 may send flooding control information of at least some of its interfaces 113 with adjacent routers 112 to those adjacent routers 112 based on receipt of a new link state message (e.g., a new LSP in IS-IS, a new LSA in OSPF, or the like). For IS-IS, for example, a router 112 may send flooding control information of at least some of its interfaces 113 with adjacent routers 112 to those adjacent routers 112 based on receipt of a new LSP and installation of the new LSP in the LSDB of the router 112 (e.g., the router 112, rather than setting the Send Receive Message (SRM) bits for all adjacencies to the “up” state, will set the SRM bit or bits to the “up” state only for the adjacency or adjacencies that are part of the sparse link-state flooding topology).

The routers 112 may send the flooding control information of the interfaces 113 to adjacent routers 112 in response to various other events or conditions.

The routers 112 may receive and handle flooding control information of interfaces 113 from adjacent routers 112 in various ways which, it will be appreciated, may depend on the manner in which the flooding control information of the interfaces 113 is sent by the adjacent routers 112. The handling of the flooding control information of interfaces 113 from adjacent routers 112 may include determining the flooding states of the interfaces 113 of the adjacent routers 112 and storing indications of the flooding states of the interfaces 113 of the adjacent routers 112 locally for use in determining whether to flood link-state information over the communication links 115 associated with the interfaces 113 of the adjacent routers 112, respectively.

In at least some embodiments, for example, where the routing protocol is IS-IS and the flooding control information is sent within IIH messages using a newly defined TLV, a router 112 receiving an IIH message associated with an interface 113 of an adjacent router 112 may be configured to determine the flooding control information for the interface 113 of the adjacent router 113 based on processing of the IIH message.

For example, where the newly defined TLV for IIH messages is a DoNotFlood (DNF) TLV, a router 112 that receives an IIH message for an interface 113 of an adjacent router 112 may be configured to determine that the absence of the DNF TLV from the IIH message indicates that the flooding state of the interface 113 is “do flood”, that presence of the DNF TLV within the IIH message with a FALSE indicator or value (e.g., “0” or the like) indicates that the flooding state of the interface 113 is “do flood”, and that presence of the DNF TLV within the IIH message with a TRUE indicator or value (e.g., “1” or the like) indicates that the flooding state of the interface 113 is “do not flood”. The router 112 that receives the IIH message for the interface 113 of the adjacent router 112 may then store the indication of the flooding state of that interface 113 of the adjacent router 112 locally for use in determining whether to flood link-state information over the communication link 115 associated with that interface 113.

For example, where the newly defined TLV for IIH messages is a DoFlood (DF) TLV, a router 112 that receives an IIH message for an interface 113 of an adjacent router 112 may be configured to determine that the absence of the DF TLV from the IIH message indicates that the flooding state of the interface 113 is “do flood”, that the presence of the DF TLV within the IIH message with a FALSE indicator or value (e.g., “0” or the like) indicates that the flooding state of the interface 113 is “do not flood”, and that presence of the DF TLV within the IIH message for with a TRUE indicator or value (e.g., “1” or the like) indicates that the flooding state of the interface 113 is “do flood”. The router 112 that receives the IIH message for the interface 113 of the adjacent router 112 may then store the indication of the flooding state of that interface 113 of the adjacent router 112 locally for use in determining whether to flood link-state information over the communication link 115 associated with that interface 113.

In at least some embodiments, for example, where the routing protocol is OSPF and flooding control information is sent within OSPF message (e.g., OSPF Hello messages, OSPF LSAs, OSPF Opaque LSAs, or the like), a router 112 receiving an OSPF message associated with an interface 113 of an adjacent router 112 may be configured to determine the flooding control information for the interface 113 of the adjacent router 113 based on processing of the OSPF message.

It will be appreciated that the routers 112 may exchange the flooding control information of the interfaces 113 with neighboring routers 112 in various other ways.

The routers 112 may maintain the flooding control information of the interfaces 113 in various ways.

The routers 112 may maintain the flooding control information of the interfaces 113 on a per-adjacency basis (e.g., for each communication link 115 connecting a pair of interfaces 113 of a pair of adjacent routers 112, each of the routers 112 maintains a flooding control state of its local interface 113 for the communication link 115 and a flooding control state of the remote interface 113 of the adjacency router 112). For example, referring again to FIG. 3, for the middle communication link 115 between router R24 and the router R14 that is the anchor node for the sparse link-state flooding topology, which has been selected as the path between router R24 and router R14 for the sparse link-state flooding topology, router R14 may maintain flooding control information for the middle communication link 115 (e.g., local interface (R14)=“do not flood” and remote interface (R24)=“do flood”) and the router R24 may maintain flooding control information for the middle communication link 115 (e.g., local interface (R24)=“do flood” and remote interface (R14)=“do not flood”).

The routers 112 may maintain the flooding control information of the interfaces 113 based on various types of state information. For example, routers 112 may maintain the flooding control information of the interfaces 113 using various types of fields, values, or the like, as well various combinations thereof. For example, a router may maintain the flooding control information of interfaces 113 using Boolean values (e.g., a value of “0” means “do not flood” and a value of “0” means “do flood”, or vice versa). For example, referring again to FIG. 3, for the middle communication link 115 between router R24 and the router R14 that is the anchor node for the sparse link-state flooding topology, which has been selected as the path between router R24 and router R14 for the sparse link-state flooding topology, router R14 may maintain flooding control information for the middle communication link 115 (e.g., local interface (R14)=“0” and remote interface (R24)=“1”) and the router R24 may maintain flooding control information for the middle communication link 115 (e.g., local interface (R24)=“1” and remote interface (R14)=“0”).

The routers 112 may maintain the flooding control information of the interfaces 113 in various other ways.

The routers 112 may use the flooding control information of the interfaces 113, for improved flooding of link-state information by the associated routing protocol, in various ways.

The routers 112 may be configured to determine flooding of link-state information over communication links 115 based on flooding control information maintained by the routers 112. The routers 112 may be configured to flood link-state information over a communication link 115 based on a determination that at least one of the interfaces 113 of the communication link 115 is set to the “do flood” state. The routers 112 may be configured to block flooding of link-state information over a communication link 115 based on a determination both of the interfaces 113 of the communication link 115 are set to the “do not flood” state.

The routers 112 may use the flooding control information of the interfaces 113, for improved flooding of link-state information by the associated routing protocol, in various other ways.

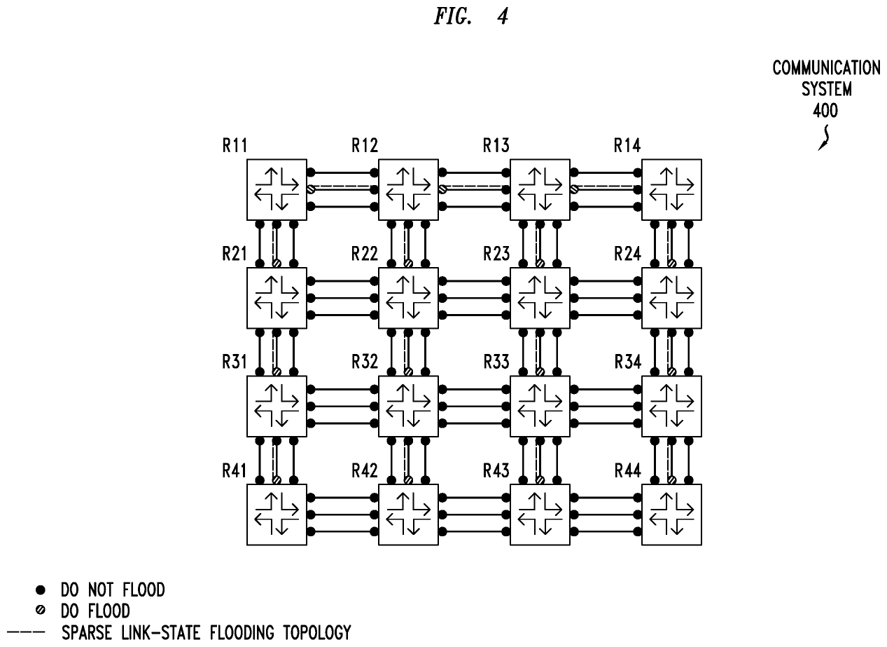

The functions performed by a router 112 to exchange flooding control information of interfaces 113 and to maintain flooding control information of interfaces 113 to provide the sparse link-state flooding topology may be further understood by way of reference to FIG. 4. FIG. 4 depicts a communication system 400, which is based on the communication system 300 of FIG. 3, in which one of the routers 112 has clamped onto the sparse link-state flooding topology. As depicted in FIG. 4, each pair of adjacent routers 112 has a communication link 115 for which at least one of the interfaces 113 is set to the “do flood” state such that, given the flooding control information maintained by the routers 112, a sparse link-state flooding topology is established. This produces a sparse link-state flooding topology a discussed further below.

For example, as depicted in FIG. 4, if router R14 has link-state information that is to be flooded to the other routers 112, router R14 will send link-state information over the middle communication link 115 with router R13 (based on a local determination by router R14 that the interface 113 on router R13 that is associated with the middle communication link 115 is set to the “do flood” state) and will send link-state information over the middle communication link 115 with router R24 (based on a local determination by router R14 that the interface 113 on router R24 that is associated with the middle communication link 115 is set to the “do flood” state).

For example, as depicted in FIG. 4, router R13 will receive the link-state information from router R14 and will send the link-state information over the middle communication link with router R12 (based on a local determination by router R13 that the interface 113 on router R13 that is associated with the middle communication link 115 is set to the “do flood” state) and will send link-state information over the middle communication link 115 with router R23 (based on a local determination by router R13 that the interface 113 on router R23 that is associated with the middle communication link 115 is set to the “do flood” state).

For example, as depicted in FIG. 4, router R24 will receive the link-state information from router R14 and will send the link-state information over the middle communication link with router R34 (based on a local determination by router R24 that the interface 113 on router R34 that is associated with the middle communication link 115 is set to the “do flood” state), but will not send the link-state information over any of the communication links 115 with router R33 (based on a local determination by router R24 that, for each of the three communication links 115, both of the interfaces 113 associated with the respective communication link 115 are set to the “do not flood” state).

It will be appreciated, with respect to FIG. 4, that flooding of the link-state information continues in this manner, based on flooding control information maintained at the routers 112, until the link-state information is received by each of the routers 112. The sparse link-state flooding topology and, thus, the path of the link-state information that is flooded, is marked by dashed lines in FIG. 4, thereby illustrating that each of the routers 112 receives the link-state information via a sparse link-state flooding topology (illustratively, each router 112 receives the link-state information via only a single communication link 115 to a single adjacent router 112) without a need for full flooding of the link-state information by every router 112 over each of its communication links 115 with each of its adjacent routers 112. Thus, it may be seen that the sparse link-state flooding topology provides a significant improvement over flooding schemes in which the link-state information would be flooded by every router 112 over each of its interfaces 113.

It will be appreciated that, although primarily presented with respect to embodiments in which flooding control information is exchanged between adjacent routers 112 based on identification of an anchor node of the link-state flooding topology, flooding control information may be exchanged between adjacent routers 112 responsive to various other conditions. For example, a router 112 may send flooding control information when the router 112 boots up, during an adjacency establishment period in which the router 112 establishes an adjacency with a neighboring router 112, based on a determination that a particular amount of link-state information has been received by the router 112 (e.g., based on a determination that the LSDB has been received, based on a determination that the entire LSDB most likely has been received, based on a determination that at least a threshold amount of the LSDB has been received, or the like), based on a periodic determination to send adjacency information (e.g., periodic exchanging of hello messages or other similar messages which may be used to maintain adjacencies between neighboring routers 112), based on failures (e.g., responsive to detection of a failure condition, responsive to recovery from a failure condition, or the like), or the like, as well as various combinations thereof. Accordingly, it will be appreciated that flooding control information may be exchanged between adjacent routers 112 responsive to various conditions, thereby enabling the sparse link-state flooding topology to be established, maintained, refined (e.g., as more information becomes available to the routers over time), and so forth.

It will be appreciated that, although primarily presented with respect to embodiments in which the flooding control information that is exchanged between adjacent routers 112 includes an indication as to whether flooding of link-state information is to be supported for a particular interface 113, in at least some embodiments the flooding control information that is exchanged between adjacent routers 112 may include additional types of information which may be used for various purposes, such as controlling flooding of link-state information between routers 112, performing troubleshooting associated with flooding of link-state information between routers 112 (e.g., the flooding control information may include one or more additional indicators (e.g., fields, values, bits, or the like) by which the router 112 may reflect back what the neighbor router 112 wants, may indicate what the router 112 thinks the neighbor router 112 wants, or the like, as well as various combinations thereof), or the like, as well as various combinations thereof.

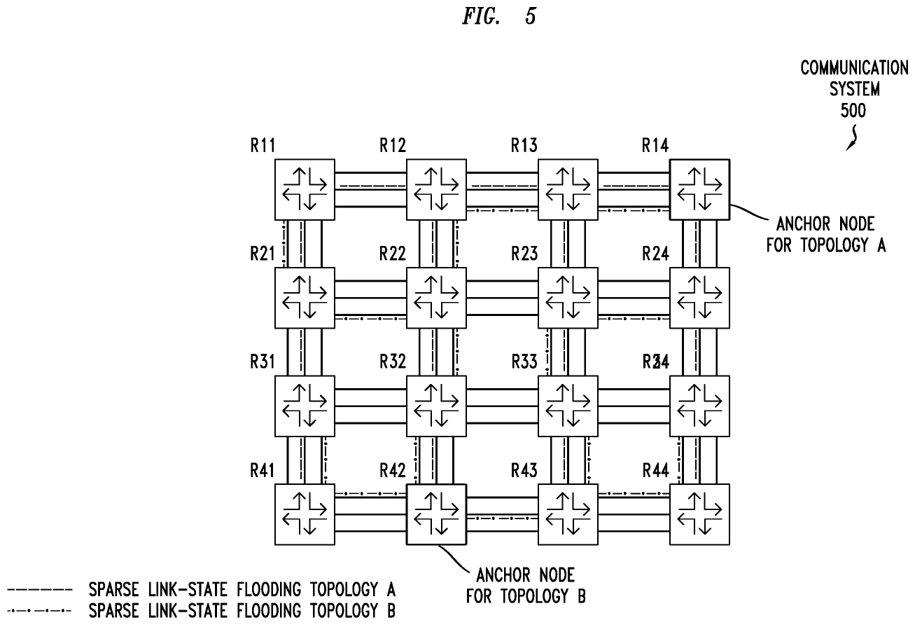

It will be appreciated that, although primarily presented with respect to embodiments in which a single sparse link-state flooding topology is established within a communication system, in at least some embodiments multiple sparse link-state flooding topologies may be established within a communication system. In at least some embodiments, multiple sparse link-state flooding topologies may be established within a communication system using a single anchor node (e.g., selecting shortest path communication links 115 for a first sparse link-state flooding topology and selecting next-to-shortest path communication links 115 for a second sparse link-state flooding topology). In at least some embodiments, multiple sparse link-state flooding topologies may be established within a communication system using multiple anchor nodes (e.g., selecting shortest path communication links 115 to a first anchor node for a first sparse link-state flooding topology and selecting shortest path communication links 115 to a second anchor node for a second sparse link-state flooding topology). An example of a communication system including multiple sparse link-state flooding topologies is presented with respect to FIG. 5. FIG. 5 depicts a communication system 500, which is based on the communication system 400 of FIG. 4, in which the sparse link-state flooding topology established based on the anchor node (illustratively, router R14 and the associated sparse link-state flooding topology indicated in FIG. 4) has been supplemented with a second sparse link-state flooding topology established based on a second anchor node (illustratively, router R42). It will be appreciated that multiple sparse link-state flooding topologies may be established within a communication system for various reasons (e.g., resiliency or the like).

FIG. 6 depicts an example embodiment of a method for use by an anchor node for supporting establishment of a sparse link-state flooding topology. It will be appreciated that, although primarily presented as being performed serially, at least a portion of the functions of method 600 may be performed contemporaneously or in a different order than as presented with respect to FIG. 6. At block 601, method 600 begins. At block 610, send, by a router of a link-state information flooding topology based on a determination that the router is an anchor node for the link-state information flooding topology, a message including an indication that the router is the anchor node for the link-state information flooding topology. At block 699, method 600 ends.

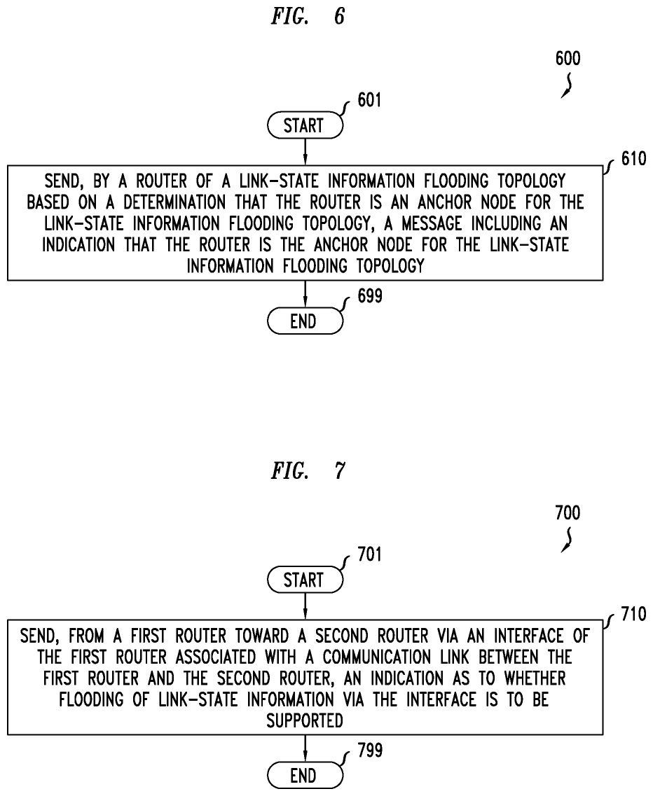

FIG. 7 depicts an example embodiment of a method for use by a router to send flooding control information for supporting establishment of a sparse link-state flooding topology. It will be appreciated that, although primarily presented as being performed serially, at least a portion of the functions of method 700 may be performed contemporaneously or in a different order than as presented with respect to FIG. 7. At block 701, method 700 begins. At block 710, send, from a first router toward a second router via an interface of the first router associated with a communication link between the first router and the second router, an indication as to whether flooding of link-state information via the interface is to be supported. At block 799, method 700 ends.

FIG. 8 depicts an example embodiment of a method for use by a router to receive flooding control information for supporting establishment of a sparse link-state flooding topology. It will be appreciated that, although primarily presented as being performed serially, at least a portion of the functions of method 800 may be performed contemporaneously or in a different order than as presented with respect to FIG. 8. At block 801, method 800 begins. At block 810, receive, at a first router from a second router via a first interface of the first router associated with a communication link between the first interface of the first router and a second interface of the second router, an indication as to whether flooding of link-state information via the second interface of the second router is to be supported. At block 899, method 800 ends.

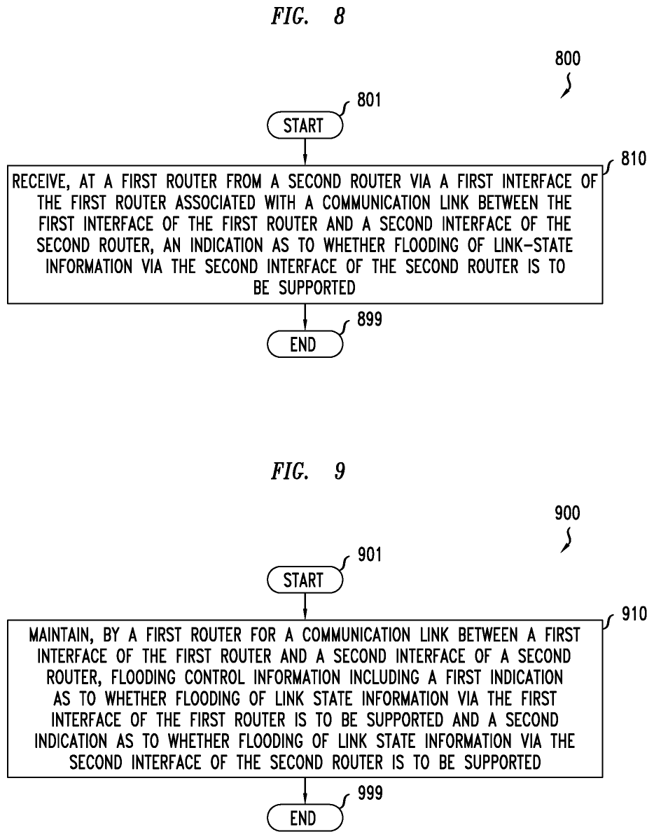

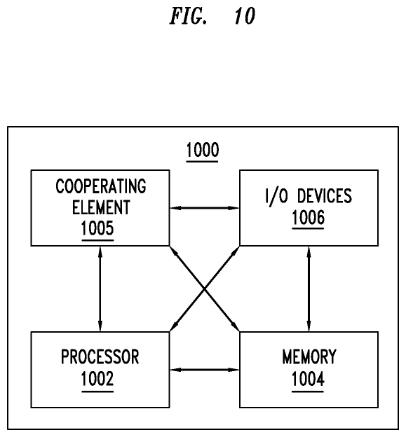

FIG. 9 depicts an example embodiment of a method for use by a router to support establishment and use of a sparse link-state flooding topology. It will be appreciated that, although primarily presented as being performed serially, at least a portion of the functions of method 900 may be performed contemporaneously or in a different order than as presented with respect to FIG. 9. At block 901, method 900 begins. At block 910, maintain, by a first router for a communication link between a first interface of the first router and a second interface of a second router, flooding control information including a first indication as to whether flooding of link state information via the first interface of the first router is to be supported and a second indication as to whether flooding of link state information via the second interface of the second router is to be supported. At block 999, method 900 ends.

Various example embodiments for supporting sparse link-state flooding for routing protocols may provide various advantages or potential advantages. For example, various example embodiments for supporting sparse link-state flooding for routing protocols may be configured to support sparse link-state flooding using a reduced or minimal link-state distribution topology (e.g., a sparse link-state distribution tree) that reduces or minimizes the amount of link-state information that is exchanged and processed in conjunction with flooding of link-state (e.g., by preventing flooding of the link-state information over every link), that is resilient and may be automatically augmented responsive to various conditions (e.g., link failures, node failures, or the like), or the like, as well as various combinations thereof. For example, various example embodiments for supporting sparse link-state flooding for routing protocols may be configured to support sparse link-state flooding in a manner that retains high availability of the routing protocols without introducing significant additional configuration of the underlying network. For example, various example embodiments for supporting sparse link-state flooding for routing protocols may be configured to support sparse link-state flooding in a manner that exploits the resiliency and dynamics (e.g., massive ECMP connectivity) within the underlying network. For example, various example embodiments for supporting sparse link-state flooding for routing protocols may be configured to support sparse link-state flooding in a manner that obviates the need for network operators to use a sub-optimal and less dynamic routing protocol (e.g., BGP) in order to prevent or minimize the effects of flooding bursts which might otherwise occur in some resilient networks, where such sub-optimal and less-dynamic routing protocol also may be at the expense of increased configuration and loss of topology-awareness. For example, various example embodiments for supporting sparse link-state flooding for routing protocols may be configured to support sparse link-state flooding in a manner that is backwards compatible with the routing protocols. Various example embodiments for supporting sparse link-state flooding for routing protocols may provide various other advantages or potential advantages.

It will be appreciated that, although primarily presented herein with respect to use of various embodiments for supporting flooding of link-state information, at least some of the embodiments presented herein may be used for or adapted for use for exchanging other types of information (e.g., other types of state information, control information, or the like, as well as various combinations thereof).

FIG. 10 depicts a high-level block diagram of a computer suitable for use in performing various functions described herein.

The computer 1000 includes a processor 1002 (e.g., a central processing unit (CPU), a processor having a set of processor cores, a processor core of a processor, or the like) and a memory 1004 (e.g., a random access memory (RAM), a read only memory (ROM), or the like). The processor 1002 and the memory 1004 may be communicatively connected.

The computer 1000 also may include a cooperating element 1005. The cooperating element 1005 may be a hardware device. The cooperating element 1005 may be a process that can be loaded into the memory 1004 and executed by the processor 1002 to implement functions as discussed herein (in which case, for example, the cooperating element 1005 (including associated data structures) can be stored on a non-transitory computer-readable storage medium, such as a storage device or other storage element (e.g., a magnetic drive, an optical drive, or the like)).

The computer 1000 also may include one or more input/output devices 1006. The input/output devices 1006 may include one or more of a user input device (e.g., a keyboard, a keypad, a mouse, a microphone, a camera, or the like), a user output device (e.g., a display, a speaker, or the like), one or more network communication devices or elements (e.g., an input port, an output port, a receiver, a transmitter, a transceiver, or the like), one or more storage devices (e.g., a tape drive, a floppy drive, a hard disk drive, a compact disk drive, or the like), or the like, as well as various combinations thereof.

It will be appreciated that computer 1000 of FIG. 10 may represent a general architecture and functionality suitable for implementing functional elements described herein, portions of functional elements described herein, or the like, as well as various combinations thereof. For example, computer 1000 may provide a general architecture and functionality that is suitable for implementing one or more elements presented herein, such as a router 112 or a portion thereof, an interface 113 or a portion thereof, a link-state flooding control element 114 or a portion thereof, or the like, as well as various combinations thereof.

It will be appreciated that at least some of the functions presented herein may be implemented in software (e.g., via implementation of software on one or more processors, for executing on a general purpose computer (e.g., via execution by one or more processors) so as to provide a special purpose computer, and the like) and/or may be implemented in hardware (e.g., using a general purpose computer, one or more application specific integrated circuits (ASIC), and/or any other hardware equivalents).

It will be appreciated that at least some of the functions presented herein may be implemented within hardware, for example, as circuitry that cooperates with the processor to perform various functions. Portions of the functions/elements described herein may be implemented as a computer program product wherein computer instructions, when processed by a computer, adapt the operation of the computer such that the methods and/or techniques described herein are invoked or otherwise provided. Instructions for invoking the various methods may be stored in fixed or removable media (e.g., non-transitory computer-readable media), transmitted via a data stream in a broadcast or other signal bearing medium, and/or stored within a memory within a computing device operating according to the instructions.

It will be appreciated that the term “or” as used herein refers to a non-exclusive “or” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. An apparatus, comprising:
at least one processor; and
at least one memory including computer program code;
wherein the at least one memory and the computer program code are configured to, with the at least one processor, cause the apparatus to at least:
receive, by a router, a message of an anchor node for a link-state flooding topology;
determine, by the router in response to the message and based on use of an algorithm by the router, flooding topology information including a communication link of the router that is part of the link-state flooding topology; and
utilize, by the router based on the flooding topology information, the communication link for flooding.

2. The apparatus of claim 1, wherein the message of the anchor node for the link-state flooding topology includes an advertisement identifying the anchor node.

3. The apparatus of claim 1, wherein the message of the anchor node for the link-state flooding topology includes an anchor type-length-value (TLV) or an anchor sub-TLV.

4. The apparatus of claim 1, wherein the algorithm includes a Shortest Path First (SPF) algorithm.

5. The apparatus of claim 1, wherein, to utilize the communication link for flooding, the at least one memory and the computer program code are configured to, with the at least one processor, cause the apparatus to at least:
receive, by the router from an adjacent router, link-state information; and
send, by the router over the communication link, the link-state information.

6. The apparatus of claim 5, wherein the link-state information includes link-state information of an Interior Gateway Protocol.

7. The apparatus of claim 1, wherein the at least one memory and the computer program code are configured to, with the at least one processor, cause the apparatus to at least:
prevent, by the router based on the flooding topology information, flooding on a second communication link of the router that is not part of the link-state flooding topology.

8. A non-transitory computer readable medium including computer program code configured to cause an apparatus to at least:
receive, by a router, a message of an anchor node for a link-state flooding topology;
determine, by the router in response to the message and based on use of an algorithm by the router, flooding topology information including a communication link of the router that is part of the link-state flooding topology; and
utilize, by the router based on the flooding topology information, the communication link for flooding.

9. The non-transitory computer readable medium of claim 8, wherein the message of the anchor node for the link-state flooding topology includes an advertisement identifying the anchor node.

10. The non-transitory computer readable medium of claim 8, wherein the message of the anchor node for the link-state flooding topology includes an anchor type-length-value (TLV) or an anchor sub-TLV.

11. The non-transitory computer readable medium of claim 8, wherein the algorithm includes a Shortest Path First (SPF) algorithm.

12. The non-transitory computer readable medium of claim 8, wherein, to utilize the communication link for flooding, the computer program code is configured to cause the apparatus to at least:
receive, by the router from an adjacent router, link-state information; and
send, by the router over the communication link, the link-state information.

13. The non-transitory computer readable medium of claim 12, wherein the link-state information includes link-state information of an Interior Gateway Protocol.

14. The non-transitory computer readable medium of claim 8, wherein the computer program code is configured to cause the apparatus to at least:
prevent, by the router based on the flooding topology information, flooding on a second communication link of the router that is not part of the link-state flooding topology.

15. A method, comprising:
receiving, by a router, a message of an anchor node for a link-state flooding topology;
determining, by the router in response to the message and based on use of an algorithm by the router, flooding topology information including a communication link of the router that is part of the link-state flooding topology; and
utilizing, by the router based on the flooding topology information, the communication link for flooding.

16. The method of claim 15, wherein the message of the anchor node for the link-state flooding topology includes an advertisement identifying the anchor node.

17. The method of claim 15, wherein the message of the anchor node for the link-state flooding topology includes an anchor type-length-value (TLV) or an anchor sub-TLV.

18. The method of claim 15, wherein the algorithm includes a Shortest Path First (SPF) algorithm.

19. The method of claim 15, wherein, utilizing the communication link for flooding includes:
receiving, by the router from an adjacent router, link-state information; and
sending, by the router over the communication link, the link-state information.

20. The method of claim 19, wherein the link-state information includes link-state information of an Interior Gateway Protocol.

21. The method of claim 15, wherein the method includes:
preventing, by the router based on the flooding topology information, flooding on a second communication link of the router that is not part of the link-state flooding topology.
